(19) United States
(12) Patent Application Publication
(10) Pub. No.: US 2020/0364693 A1
(43) Pub. Date: Nov. 19, 2020

(54) SYSTEM, METHOD, AND COMPUTER PROGRAM FOR PROCESSING DATA USING TRANSACTION INFORMATION

(71) Applicant: SOFTLUNCH INC., Seoul (KR)

(72) Inventor: Jin Heung BAE, Seoul (KR)

(73) Assignee: SOFTLUNCH INC., Seoul (KR)

(21) Appl. No.: 16/516,587

(22) Filed: Jul. 19, 2019

(30) Foreign Application Priority Data
May 16, 2019 (KR) 10-2019-0057597

(51) Int. Cl. G06Q 20/32; G06Q 20/38; G06Q 20/36; H04L 29/08

(52) U.S. Cl. CPC G06Q 20/3223; H04L 67/306; G06Q 20/363; G06Q 20/3821

(57) ABSTRACT

A method of processing data using transaction information includes a user terminal detecting context data related to transaction data through one of a sensor unit and a communication unit, the user terminal generating transaction-context data regarding a transaction, taking into account the context data related to the transaction data, the user terminal generating processed transaction data based on the transaction-context data, and the user terminal outputting the processed transaction data through an output unit.

### CROSS-REFERENCE TO RELATED APPLICATION

This application claims the benefit of Korean Patent Application No. 10-2019-0057597, filed on May 16, 2019, in the Korean Intellectual Property Office, the disclosure of which is incorporated herein in its entirety by reference.

### BACKGROUND

### 1. Field

One or more example embodiments relate to a system, method, and computer program for processing data using transaction information.

### 2. Description of the Related Art

For consumption in modern society, the frequency of transactions using payment or trading methods using various media has been on the rise, and accordingly, the importance of analysis and management of transactions has been emphasized. In particular, since many people carry mobile terminals, systems for performing a transaction using a mobile terminal have been developed.

According to the related art, transaction management methods focus on recording a transaction itself, and therefore, it is difficult to acquire meaningful information about a user from the transaction.

### SUMMARY

One or more embodiments include a system, method, and computer program for generating transaction-related big data using transaction information by generating processed transaction data using transaction data received in correspondence to a transaction and using context data sensed at a time when the transaction data is received.

Additional aspects will be set forth in part in the description which follows and, in part, will be apparent from the description, or may be learned by practice of the presented embodiments.

According to one or more embodiments, a method of processing data using transaction information includes a user terminal detecting context data related to transaction data through one of a sensor unit and a communication unit; the user terminal generating transaction-context data regarding a transaction, using the context data related to the transaction data; the user terminal generating processed transaction data based on the transaction-context data; and the user terminal outputting the processed transaction data through an output unit.

The outputting of the processed transaction data may include rendering a virtual space taking into account a piece of attribution information selected from the context data and calculating deployment information of the transaction data to correspond to the piece of attribution information in the virtual space; and deploying and displaying the processed transaction data in the virtual space based on the deployment information.

The generating of the transaction-context data may include generating the transaction-context data from the transaction data using the context data related to the transaction data, the transaction-context data including payment means information, payment period information, a payment amount, a payment occurrence location, a payment time, and an accumulated amount on a payment means with respect to the transaction.

The outputting of the processed transaction data may include outputting only part of the processed transaction data according to a user input.

The transaction data may be generated in correspondence to the transaction of a user.

The transaction data may be generated when a user input matching a certain condition is received.

The context data may be detected in connection with a generation time of the transaction data when the transaction data is generated before the transaction data is received.

The context data may be generated in the user terminal near a generation time of the transaction data and may include at least one selected from a photograph, a posting, and a memo, each being generated using an application installed in the user terminal.

According to one or more embodiments, a computer program is stored in a computer-readable storage medium and, when executed using a computer, performs a method of processing data using transaction information, wherein the method includes a user terminal detecting context data related to transaction data through one of a sensor unit and a communication unit; the user terminal generating transaction-context data regarding a transaction, taking into account the context data related to the transaction data; the user terminal request context data related to the transaction-context data from a data processing server and receiving the context data; the user terminal generating processed transaction data based on the transaction-context data; and the user terminal outputting the processed transaction data through an output unit.

The outputting of the processed transaction data may include rendering a virtual space taking into account a piece of attribution information selected from the context data and calculating deployment information of the transaction data to correspond to the attribution information in the virtual space; and deploying and displaying the processed transaction data in the virtual space based on the deployment information.

The generating of the transaction-context data may include generating the transaction-context data from the transaction data using the context data related to the transaction data, the transaction-context data including payment means information, payment period information, a payment amount, a payment occurrence location, a payment time, and an accumulated amount on a payment means with respect to the transaction.

The outputting of the processed transaction data may include outputting only part of the processed transaction data according to a user input.

The transaction data may be generated in correspondence to the transaction of a user and received through an external server.

The transaction data may be generated when a user input matching a certain condition is received.

The context data may be detected in connection with a generation time of the transaction data when the transaction data is generated before the transaction data is received.

The context data may be generated in the user terminal near a generation time of the transaction data and may include at least one selected from a photograph, a posting, and a memo, each being generated using an application installed in the user terminal.

In addition, another method and system for realizing one or more embodiments and a computer-readable recording medium having recorded thereon a computer program, which performs the method, may also be provided.

Other aspects, features, and advantages than those described above will be clear from the accompanying drawings, the claims, and the description of embodiments below.

### BRIEF DESCRIPTION OF THE DRAWINGS

These and/or other aspects will become apparent and more readily appreciated from the following description of the embodiments, taken in conjunction with the accompanying drawings in which:

FIG. 1 is a diagram of an example of a data processing system according to one or more embodiments;

FIG. 2 is a block diagram of the structure of a user terminal;

FIG. 3 is a block diagram of the structure of a storage of a user terminal;

FIG. 4 is a diagram showing data flow among a user terminal, a communication server, and a data processing server, according to one or more embodiments;

FIG. 5 is a flowchart of a data processing method according to one or more embodiments;

FIG. 6 is a flowchart of a data processing method according to one or more embodiments;

FIG. 7 is a diagram of an example of a data processing system according to one or more embodiments;

FIG. 8 is a diagram showing a flowchart among a user terminal, a communication server, and a data processing server, according to one or more embodiments;

FIG. 9 is a diagram showing a flowchart among a user terminal, a communication server, and a data processing server, according to one or more embodiments; and

FIG. 10 is a diagram for explaining a process of generating transaction-related big data using a data processing system.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Example embodiments will be described in detail with reference to the accompanying drawings. In addition, a method of configuring and using an electronic device, according to an embodiment, will be described in detail with reference to the accompanying drawings. In the drawings, like reference numerals or characters denote like components or elements performing substantially the same function.

While terms including ordinal numbers such as “first,” “second,” etc., may be used to describe various components, such components must not be limited to the above terms. The above terms are used only to distinguish one component from another. For example, a first component could be termed a second component, and, similarly, a second component could be termed a first component without departing from the scope of the present disclosure. The term “and/or” includes combinations of a plurality of associated listed items or one of the associated listed items.

The terms used in the present specification are merely used to describe example embodiments and are not intended to limit embodiments. An expression used in the singular encompasses the expression of the plural, unless it has a clearly different meaning in the context. In the present specification, it is to be understood that the terms such as “including,” “having,” and “comprising” are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

In the specification, when a portion is referred to as being “connected” or “coupled” to another portion, it may be “directly connected or coupled” to the other portion or may be “electrically connected” to the other portion with an intervening element therebetween. When a portion “comprises” or “includes” an element, it means that the portion may further comprise or include other elements and does not preclude the presence other elements unless stated otherwise. As used herein, terminology such as “part (or unit)” and “module” may indicate a unit which processes at least one function or operation and may be implemented by hardware, software, or a combination thereof.

In the specification, transaction data may be generated in correspondence to a user's action and may include a certain time, a certain location, and/or a transaction using a mobile device at the certain location at the certain time. The transaction data may have various formats, such as short messages transmitted and received through a mobile communication network, push messages transmitted and received through an Internet network, and messages transmitted and received through various communication networks, and are not limited thereto.

In the specification, processed transaction data refers to semantic data, which is inferred in correspondence to a user's transaction by connecting information included in transaction data with information grasped as context data. The processed transaction data may include a user's location, time, the user's schedule information stored in a mobile device, and/or transaction description and may be obtained by combining an occurrence location and time collected through the context data, past transaction information, future transaction information, clustering of collected transaction information, and so on.

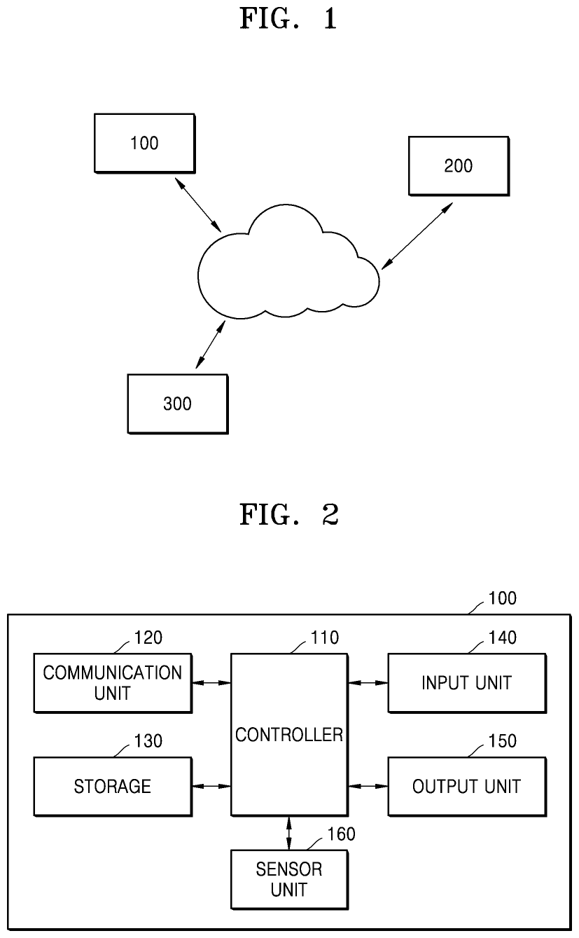

FIG. 1 is a diagram of an example of a data processing system according to one or more embodiments.

As shown in FIG. 1, the data processing system may include a user terminal 100, a communication server 200, and a data processing server 300.

The user terminal 100 may be implemented as an electronic device, which communicates with the communication server 200 and/or the data processing server 300 in a wired/wireless communication environment, and may include at least one selected from a smartphone, a tablet personal computer (PC), a mobile phone, a video phone, an e-book reader, a desktop PC, a laptop PC, a netbook computer, a workstation, a server, a personal digital assistant (PDA), a portable multimedia player (PMP), an MP3 player, a mobile medical device, a camera, and a wearable device. The user terminal 100 may include a processor, a storage medium, a communication module, and/or an input/output device. The user terminal 100 receives a message related to a transaction and collects context data connected with transaction data and/or transaction data notification. The user terminal 100 may generate a data format by combining the transaction data, the transaction data notification, and the context data connected with the transaction data and/or the transaction data notification. The user terminal 100 may generate transaction-context data.

The communication server 200 transmits the transaction data and/or the transaction data notification to the user terminal 100. The communication server 200 transmits the transaction data and/or the transaction data notification in a short message format or a push message format.

The data processing server 300 may generate transaction-context data inferred about the occurrence of the transaction using the transaction data, the transaction data notification, and the context data collected in connection with the transaction data and/or the transaction data notification.

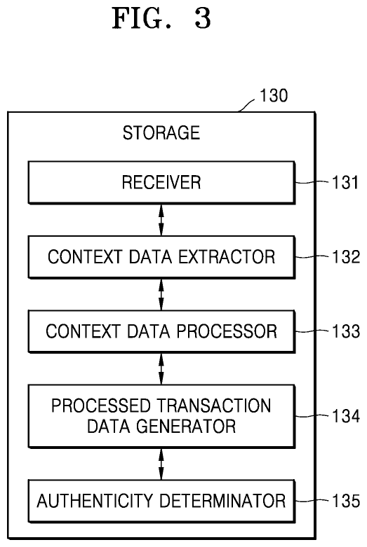

FIG. 2 is a block diagram of the structure of the user terminal 100. FIG. 3 is a block diagram of the structure of a storage 130 of the user terminal 100.

As shown in FIG. 2, the user terminal 100 may include a controller 110, a communication unit 120, the storage 130, an input unit 140, and a display unit 150 to receive transaction data and/or transaction data notification, to detect context data, and to generate transaction-context data using the transaction data, the transaction data notification, and the context data.

The controller 110 may be configured to process a command in a computer program by performing basic arithmetic, logical, and input/output operations. The command may be provided from the storage 130 and/or the communication unit 120 to the controller 110. For example, the controller 110 may be configured to execute the received command according to program code stored in a recording device like the storage 130.

The communication unit 120 may provide a function for communicating with an external device through a network. For example, a request (e.g., a messaging service request), which is generated by the controller 110 of the user terminal 100 according to program code stored in a recording device like the storage 130, may be transmitted to an external server or another user terminal through a network under the control of the communication unit 120. For example, a control signal or a command, which is received through the communication unit 120, may be transmitted to the controller 110 or the storage 130, and content or a file may be stored in a storage medium, which may be additionally included in the user terminal 100.

The storage 130 may be implemented as a computer-readable recording medium and may include a permanent mass storage device such as random access memory (RAM), read-only memory (ROM), or a disk drive. In addition, an operating system (OS) and at least one set of program code may be stored in the storage 130. Such software components may be loaded from another computer-readable recording medium than the storage 130 using a drive mechanism. Another computer-readable recording medium may include a floppy drive, a disk, tape, a DVD/CD-ROM drive, or a memory card. According to one or more embodiments, software components may be loaded to the storage 130 through the communication unit 120 instead of a computer-readable recording medium. For example, at least one program may be loaded to the storage 130 based on a program (e.g., an application), which is installed using files provided through a network by a developer or a file distribution system distributing the application's setup files.

The input unit 140 refers to a means enabling a user to input data for controlling the user terminal 100. For example, the input unit 140 may include a key pad, a dome switch, a touch pad (e.g., a contact electrostatic capacitive type, a pressure resistive film type, an infrared detection type, a surface acoustic wave propagation type, an integral strain gauge type, or a piezoelectric-effect type), a jog wheel, or a jog switch but is not limited thereto.

The output unit 150 outputs information processed by the user terminal 100. For example, the output unit 150 may output a user interface providing processed transaction data. Meanwhile, when a touch screen is formed by a layer structure of the output unit 150 and a touch pad, the output unit 150 may also be used as an input device.

The output unit 150 may include at least one selected from a liquid crystal display (LCD), a thin film transistor-LCD (TFT-LCD), an organic light-emitting diode (OLED) display, a flexible display, a three-dimensional (3D) display, and an electrophoretic display. The user terminal 100 may include at least two output units 150 according to an implementation type thereof. At this time, the output units 150 may be arranged to face each other using a hinge.

A sensor unit 160 may include at least one selected from a magnetic sensor, an acceleration sensor, a temperature/humidity sensor, an infrared sensor, a gyroscope sensor, a position sensor (e.g., a global positioning system (GPS)), an atmospheric pressure sensor, a proximity sensor, an RGB sensor, and an illuminance sensor but is not limited thereto. The function of each sensor may be intuitively inferred from the name of the sensor by those skilled in the art, and therefore, the detailed descriptions thereof will be omitted.

The sensor unit 160 may obtain status information of the user terminal 100. The sensor unit 160 may obtain information about at least one selected from a slope of the user terminal 100, a positional direction of the user terminal 100, and a motion of the user terminal 100.

In addition, the sensor unit 160 may sense a user input. The sensor unit 160 may obtain information about at least one selected from the length of time of the user input and the type of the user input.

As shown in FIG. 3, the storage 130 may include a receiver 131, a context data extractor 132, a context data processor 133, a processed transaction data generator 134, and an authenticity determinator 135.

The receiver 131 receives transaction data and/or transaction data notification, each corresponding to a user's transaction using a mobile device.

In one or more embodiments, the receiver 131 may generate the transaction data according to a user input. The transaction data may be generated in response to a user input matching a certain condition.

The context data extractor 132 generates context data related to transaction data using the sensor unit 160 or a peripheral electronic device. The context data processor 133 generates the context data at a time when the transaction data is received, using the sensor unit 160 or the peripheral electronic device. The context data extractor 132 may sense location information, weather information, and/or biometric information or detect a signal from the peripheral electronic device and generate the context data.

The context data may be generated by combining information, such as a detected signal, related to an ambient environment and sensed data such as location information, weather information, or biometric information. The context data may be generated using transaction data, information related to an ambient environment like a detected signal, and sensed data like location information, weather information, or biometric information. In detail, the context data may include location information connected with the transaction data. The location information detected or sensed at a time when the transaction data is received may be stored in connection with a transaction.

In one or more embodiments, context data may be generated based on a signal, which is received in connection with transaction data. The signal is received through a peripheral device during a certain time period starting from a time when the transaction data is received (or generated). The signal is connected with transaction data, which is received during a target time period close to a transaction data-receiving time when the transaction data is received. The signal may inform the location of the user terminal 100 and a place the user terminal 100 visited.

Context data may include content generated at a time close to a transaction data generation time when transaction data is generated and/or content generated in a location adjacent to a transaction data generation location where the transaction data is generated. The context data may be generated through various applications, such as a photographing application, a social networking service (SNS) application, a writing application, a memo application, a calendar application, and a group application, which are installed in the user terminal 100, at the time close to the transaction data generation time. All or some of the context data generated near the transaction data generation time may be selected according to a user input.

When transaction data is received, the context data processor 133 may request and receive transaction-context data related to the transaction data from the data processing server 300. The context data processor 133 may convert the transaction data into transaction-context data regarding a transaction, using the transaction data and context data.

Transaction-context data regarding a transaction may be generated by connecting means information, installment information, a transaction amount, an on- or off-line occurrence location (e.g., an offline location or route information such as a website and clicking online), an occurrence time, and/or an accumulated amount, each being extracted from transaction data, with context data (e.g., location information, address information corresponding to a location, or a business name or a place name of a visited place).

The context data processor 133 receives transaction-context data such as location-of-occurrence information regarding a transaction, menu information corresponding to a transaction amount, or timing information at a transaction occurrence time. Timing information at a transaction occurrence time may be obtained through the number of clients at the transaction occurrence time, age group information, the nature of a client group (e.g., family, a couple, friends, or colleagues), a transaction amount at a table, and/or the chronological order of transactions in a corresponding day. The timing information is used to determine the meaning, value, or evaluation of the transaction through a plurality of mobile devices. For example, the timing information at the transaction occurrence time may be determined in proportion to the value, meaning, or evaluation of the transaction at the transaction occurrence time by determining whether the transaction of a user occurs in a time zone having a high rate of visits and transactions, which have a similar nature to the user's.

The processed transaction data generator 134 may generate processed transaction data by combining transaction data with context data or based on transaction-context data. Processed transaction data may be generated by converting transaction-context data into a visualized icon in a virtual space. Processed transaction data refers to data deployed in a virtual space by connecting transaction data with context data. Deployment information of transaction data in a virtual space may be determined based on attribution information of context data related to the transaction data or attribute information of the transaction data. Deployment information of transaction data may be determined based on at least one piece of information selected from location-related attribute information, time-related attribute information, and amount-related attribute information according to the nature of a virtual space. In one or more embodiments, the processed transaction data generator 134 may be configured to generate processed transaction data with respect to transaction data satisfying a certain criterion. The processed transaction data generator 134 may transmit processed transaction data selected based on a certain criterion, randomly selected processed transaction data, or all processed transaction data to the data processing server 300. For example, the processed transaction data generator 134 may transmit processed transaction data generated in a certain location range or processed transaction data generated in a certain time range to the data processing server 300. Processed transaction data may be transmitted to the data processing server 300 immediately after being generated or after being packetized into certain units.

The authenticity determinator 135 determines authenticity of transaction data or transaction-context data. The authenticity may be about whether the transaction data or the transaction-context data is the one that has actually been generated. The authenticity determinator 135 may compare transaction data with context data to determine the authenticity of the transaction data. The authenticity determinator 135 may determine the authenticity of transaction data based on transaction-context data. The authenticity determinator 135 may determine the authenticity of transaction data based on whether a transaction occurrence location obtained from the transaction data coincides with location information obtained from context data, wherein the location information corresponds to a transaction occurrence time.

When the authenticity of transaction data is true, context data related to the transaction data may be requested. When a location obtained from context data coincides with place-of-occurrence information regarding a transaction, the authenticity of transaction data may be determined to be true. When place-of-occurrence information regarding a transaction indicates a place, which is adjacent to a location obtained from context data, for example, which is within a predetermined distance of 50 m from the location, the authenticity of transaction data may be determined to be true.

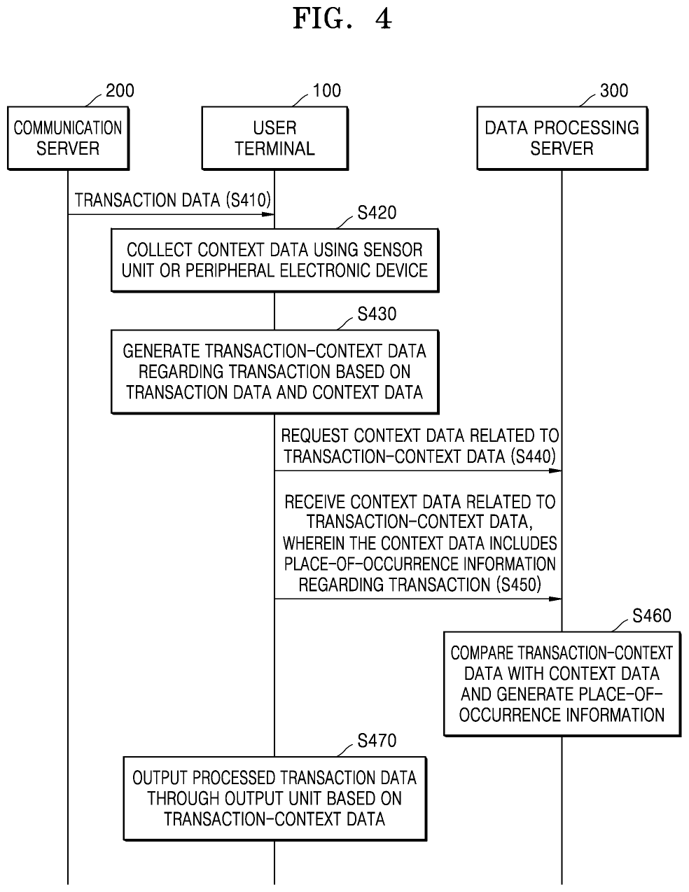

FIG. 4 is a diagram showing data flow among the user terminal 100, the communication server 200, and the data processing server 300, according to one or more embodiments.

According to one or more embodiments, transaction-context data may be generated based on transaction data and/or context data. According to one or more embodiments, transaction-related big data may be generated using pieces of transaction data or context data, which are generated in correspondence to a transaction using a mobile device.

The user terminal 100 may receive transaction data from the data processing server 300 in operation S410. The communication server 200 may transmit the transaction data to the user terminal 100, which is specified, according to a request from a financial company server. The user terminal 100 that receives the transaction data may be analyzed using the transaction data.

The user terminal 100 collects context data related to the transaction data using a sensor unit or a peripheral electronic device in operation S420. The user terminal 100 generates the context data at a transaction data-receiving time, using the sensor unit or the peripheral electronic device. The user terminal 100 may sense location information, weather information, and/or biometric information or detect a signal from the peripheral electronic device to generate the context data.

The context data may be generated by combining sensed data, such as the location information, the weather information, and/or the biometric information, and the detect signal, and the context data may be generated in connection with the transaction data. In detail, the context data may include location information connected with the transaction data. The location information detected or sensed at a transaction data-receiving or generation time may be stored in connection with the occurrence of the transaction.

In one or more embodiments, the context data may be generated based on a signal, which is received in connection with the transaction data. The signal is received through a peripheral device during a certain time period starting from a transaction data-receiving time. The signal is connected with the transaction data, which is received close to a target time point like the transaction data-receiving time. The signal may inform the location of the user terminal 100 and a place the user terminal 100 visited.

The context data may include content generated at a time close to the transaction data generation time and/or content generated in a location adjacent to where the transaction data is generated. The context data may be generated through various applications, such as a photographing application, an SNS application, a writing application, a memo application, a calendar application, and a group application, which are installed in the user terminal 100, at the time close to the transaction data generation time. All or some of the context data generated near the transaction data generation time may be selected according to a user input.

The user terminal 100 may generate the transaction data into transaction-context data regarding the transaction, based on the context data related to the transaction data, in operation S430. The transaction-context data may be generated by connecting transaction means information, installment information, a transaction amount, a transaction occurrence location, a transaction occurrence time, and an accumulated amount, each being extracted from the transaction data, with context data (e.g., location information including a latitude and a longitude, address information corresponding to a location, or a business name or a place name of a visited place).

The user terminal 100 requests context data related to the transaction-context data from the data processing server 300 in operation S440. The user terminal 100 receives the context data related to the transaction-context data in operation S450. The user terminal 100 receives the context data such as location-of-occurrence information regarding a transaction, menu information corresponding to a transaction amount, or timing information at the transaction occurrence time. The timing information at the transaction occurrence time may be obtained through the number of clients at the transaction occurrence time, age group information, the nature of a client group (e.g., family, a couple, friends, or colleagues), a transaction amount at a table, and/or the chronological order of transactions in a corresponding day. The timing information is used to determine the meaning, value, or evaluation of the transaction through a plurality of mobile devices. For example, the timing information at the transaction occurrence time may be determined in proportion to the value, meaning, or evaluation of the transaction at the transaction occurrence time by determining whether the transaction of a user occurs in a time zone having a high rate of visits and transactions, which have a similar nature to the user's.

The data processing server 300 may compare transaction data received through another user terminal 100 with transaction data stored in a server to determine the authenticity of the transaction data received through the user terminal and may generate location-of-occurrence information regarding the transaction data having the authenticity in operation S460. Here, the transaction data may be obtained through a financial company server or generated by a user input.

The user terminal 100 outputs processed transaction data through an output unit based on the transaction-context data in operation S470. Processed transaction data refers to data deployed in a virtual space by connecting the transaction data with the context data or data deployed in a virtual space based on the transaction-context data. Deployment information of the transaction data in the virtual space may be determined based on the context data related to the transaction data or the transaction-context data. The deployment information of the transaction data may be determined based on at least one factor selected from a location, a time, and a transaction amount.

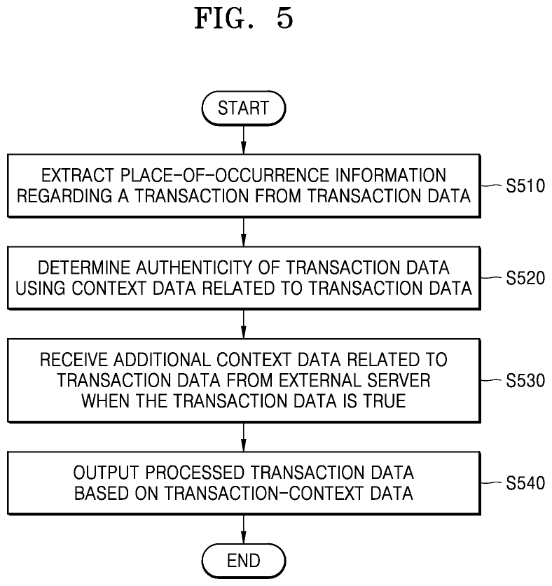

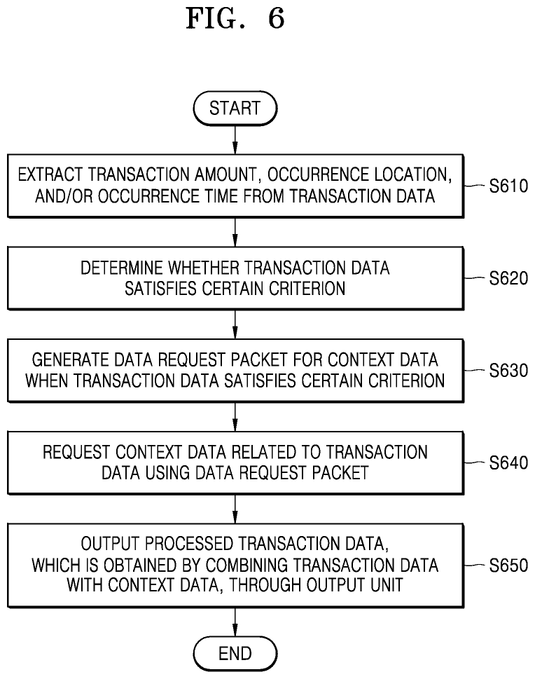

FIGS. 5 and 6 are flowcharts of a data processing method according to one or more embodiments.

Referring to FIG. 5, the user terminal 100 extracts place-of-occurrence information regarding a transaction from transaction data in operation S510.

The user terminal 100 may determine the authenticity of the transaction data or the place-of-occurrence information using context data related to the transaction data in operation S520. When a location obtained from the context data coincides with the place-of-occurrence information, the authenticity of the transaction data may be determined to be true.

When the transaction data is determined to be true, The user terminal 100 may receive additional context data related to the transaction data from an external server (e.g., a portal server, an SNS server, or a financial company server) in operation S530. The data processing server 300 may extract context data using various forms or formats such as a photograph and an expression, which are included in a posting uploaded to an SNS server.

The user terminal 100 outputs processed transaction data by combining the transaction data with the context data in operation S540. The user terminal 100 may output the processed transaction data based on transaction-context data. The processed transaction data is generated in correspondence to the transaction that has occurred and is rendered in a virtual space according to deployment information thereof. The deployment information may include a location, a direction, a size, or the like. The processed transaction data may change into different deployment information according to the category thereof and may be deployed in a virtual space corresponding to the category.

As such, the user terminal 100 may convert the transaction data into the processed transaction data and visually provide the meaning of the processed transaction data.

Referring to FIG. 6, the user terminal 100 extracts a transaction amount, an occurrence location, and/or an occurrence time from transaction data in operation S610.

The user terminal 100 determines whether the transaction data satisfies a certain criterion. For example, the certain criterion may be set like the following: the transaction amount is equal to or greater than a certain amount; the occurrence location is near a predetermined place, e.g., Gyeongnidan-gil in Seoul; or the occurrence time is a predetermined time, e.g., from 10 PM to midnight. The user terminal 100 may change the certain criterion via a user input.

When the transaction data is determined to satisfy the certain criterion in operation S620, the user terminal 100 generates a data request packet for the context data in operation S630. The user terminal 100 requests context data related to the transaction data using the data request packet in operation S640.

The user terminal 100 outputs processed transaction data, which is obtained by combining the transaction data with the context data, through an output unit in operation S650.

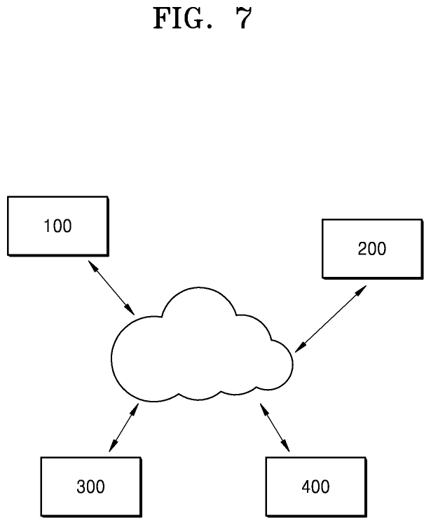

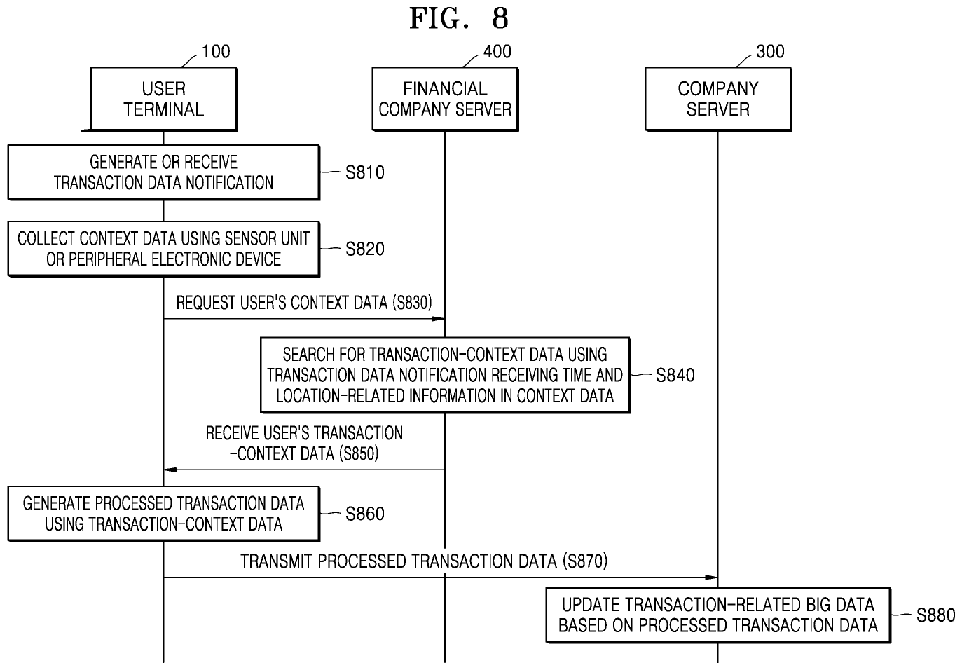

FIG. 7 is a diagram of components of a data processing system, according to one or more embodiments. FIG. 8 shows flowcharts among the user terminal 100, the data processing server 300, and a financial company server 400.

Referring to FIG. 7, the data processing system may further include the financial company server 400. The financial company server 400 may generate transaction data with respect to transactions performed using a plurality of mobile devices and transmit transaction data to the user terminal 100. The financial company server 400 may extract and provide transaction data of a particular user in response to a request from the data processing server 300.

The user terminal 100 may receive transaction data notification from the communication server 200 or autonomously generate transaction data notification in operation S810. The transaction data notification may be generated when an event matching a certain condition occurs. The communication server 200 may transmit the transaction data notification to the user terminal 100 in response to a request from the financial company server 400. The transaction data notification may be generated in correspondence to a use of a card and implemented as visual or auditory data and may include the transaction data including transaction information, wherein the transaction data has been described with reference to FIG. 4.

The user terminal 100 collects context data related to the transaction data notification using a sensor unit or a peripheral electronic device in operation S820. The user terminal 100 may generate context data at a time when the transaction data notification is received, using a sensor unit or a peripheral electronic device. The user terminal 100 may generate context data by sensing location information, weather information, and/or biometric information or detecting a signal from a peripheral electronic device.

The context data may be generated by combining sensed data, such as the location information, the weather information, and/or the biometric information, and the detect signal. The context data may be generated in connection with the transaction data and/or the transaction data notification. In detail, the context data may include location information and/or time information, each connected with the transaction data notification. The location information, which is detected or sensed at a transaction data notification receiving time when the transaction data notification is received, may be stored in connection with use of a transaction means.

In one or more embodiments, the context data may be generated based on a signal, which is received in connection with the transaction data notification. The signal is received through a peripheral device during a certain time period starting from the transaction data notification receiving time. The signal is connected with the transaction data, which is received close to a target time point like the transaction data notification receiving time. The signal may inform a location and a travel route of the user terminal 100 and a place the user terminal 100 visited.

The context data may include content generated at a time close to a transaction data generation time and/or content generated in a location adjacent to where the transaction data is generated. The context data may be generated through various applications, such as a photographing application, an SNS application, a writing application, a memo application, a calendar application, and a group application, which are installed in the user terminal 100, at the time close to the transaction data generation time. All or some of the context data generated near the transaction data generation time may be selected according to a user input.

The user terminal 100 requests context data from the financial company server 400 in operation S830. The financial company server 400 searches for transaction-context data using the transaction data notification receiving time and location-related information of the context data in operation S840.

The user terminal 100 receives the transaction-context data corresponding to the user from the financial company server 400 in operation S850. At this time, to transmit or receive transaction-context data, the user terminal 100 may access the financial company server 400 and undergo an acceptance process, an approval process, or the like for information request and reception. After undergoing such pre-process in the financial company server 400, the user terminal 100 may transmit or receive the transaction-context data.

The user terminal 100 generates processed transaction data using the transaction-context data in operation S860.

The user terminal 100 transmits the processed transaction data to the data processing server 300 in operation S870.

The data processing server 300 may update transaction-related big data based on the processed transaction data received from the user terminal 100 in operation S880. Transaction-related big data may be generated by clustering processed transaction data according to various criteria. Transaction-related big data may calculate social meaning related to consumption behavior, e.g., a time-sequential order and meaning of consumptions, by analyzing the occurrence order of users' transactions obtained from the processed transaction data. Transaction-related big data may be generated to present the order of consecutive consumptions. A day having a high frequency of transactions may be selected, and transaction-related big data may be generated based on the order of 1-1 consumption, 1-2 consumption, and 1-3 consumption, which occur on the day. Transaction-related big data may present the order of consumptions occurring at certain time intervals. Transaction-related big data may be presented based on the order of 2-1 consumption, 2-2 consumption, and 2-3 consumption, which occur at predetermined time intervals, e.g., at two-day intervals, at three-day intervals, or at one-week intervals.

Transaction-related big data may be generated based on changes in a transaction amount. Transaction-related big data may be generated based on changes in a payment amount with respect to locations, using processed transaction data. For example, transaction-related big data may be generated by presenting regional average payment amounts, such as an average payment amount of X in region A and an average payment amount of Y in region B, or by deploying items on a content, which visually shows regions, wherein each item has a size corresponding to an average payment amount.

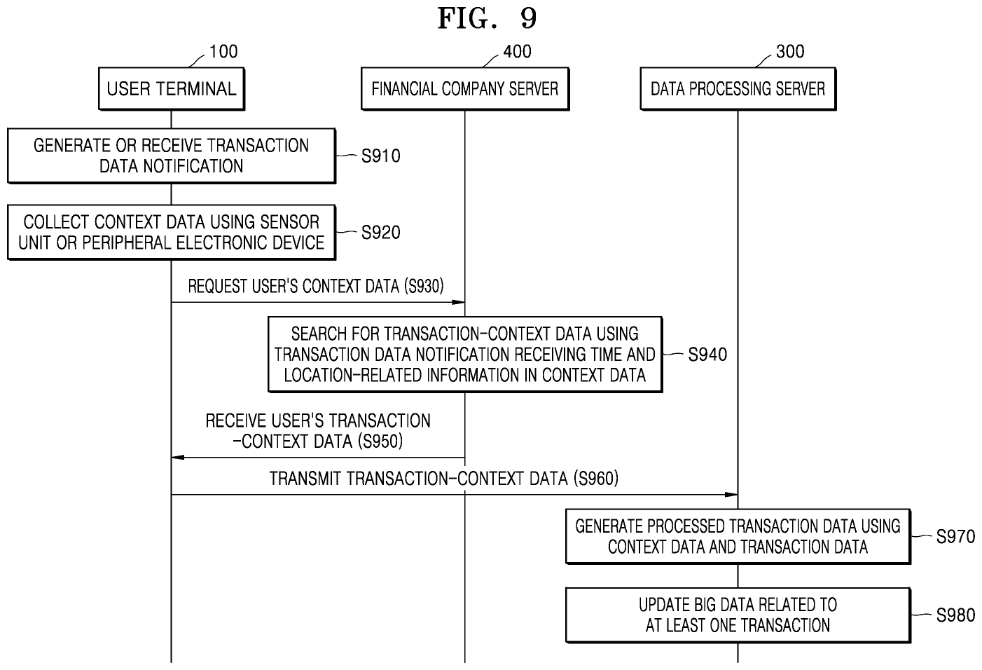

FIG. 9 is a diagram for explaining data flow among the user terminal 100, the data processing server 300, and the financial company server 400.

The user terminal 100 may receive transaction data notification from the communication server 200 or autonomously generate transaction data notification in operation S910. The user terminal 100 collects context data related to the transaction data notification using a sensor unit or a peripheral electronic device in operation S920.

The user terminal 100 requests context data related to a user's latest transaction from the financial company server 400 in operation S930. Here, the latest transaction may be any transaction using a mobile device, which occurs near a transaction data notification generation time or a transaction data notification generation location.

The financial company server 400 searches for transaction-context data related to a transaction, which occurs near a location corresponding to location-related information of the context data, using a transaction data notification receiving time and the location-related information of the context data in operation S940 and transmits the transaction-context data to the user terminal 100 in operation S950.

The user terminal 100 transmits the transaction-context data to the data processing server 300 in operation S960.

The data processing server 300 generates processed transaction data using the transaction data notification, the context data, and transaction data in operation S970. The data processing server 300 may update transaction-related big data by analyzing at least one piece of processed transaction data according to various criteria in operation S980.

Transaction-related big data may be generated by clustering processed transaction data according to various criteria. Transaction-related big data may be implemented by creating a virtual space such as a location space for locations, a time space for times, or a payment amount space for payment amounts, and including processed transaction data in the created virtual space. For example, transaction-related big data may deploy processed transaction data in a location space based on a payment location or a user location each included in the processed transaction data. Transaction-related big data may deploy processed transaction data in a payment amount space based on a payment amount or a unit price, each included in the processed transaction data.

Transaction-related big data may calculate a time-sequential order and meaning of consumptions by analyzing the occurrence order of users' transactions, which is obtained from processed transaction data. Transaction-related big data may be generated to present the order of consecutive consumptions. A day having a high frequency of transactions may be selected, and transaction-related big data may be generated based on the order of 1-1 consumption, 1-2 consumption, and 1-3 consumption, which occur on the day. Transaction-related big data may present the order of consumptions occurring at certain time intervals. Transaction-related big data may be presented based on the order of 2-1 consumption, 2-2 consumption, and 2-3 consumption, which occur at predetermined time intervals, e.g., at two-day intervals, at three-day intervals, or at one-week intervals.

Transaction-related big data may be generated based on changes in a payment amount. Transaction-related big data may be generated based on changes in a payment amount with respect to locations, using processed transaction data. For example, transaction-related big data may be generated by presenting regional average payment amounts, such as an average payment amount of X in region A and an average payment amount of Y in region B, or by deploying items on content, which visually shows regions, wherein each item has a size corresponding to an average payment amount.

At this time, the data processing server 300 may generate transaction-related big data according to an input criterion for classification. Transaction-related big data may be generated using transaction data limited by a transaction occurrence location, a transaction range or zone, a transaction time, and/or an age group of a consumer in a transaction.

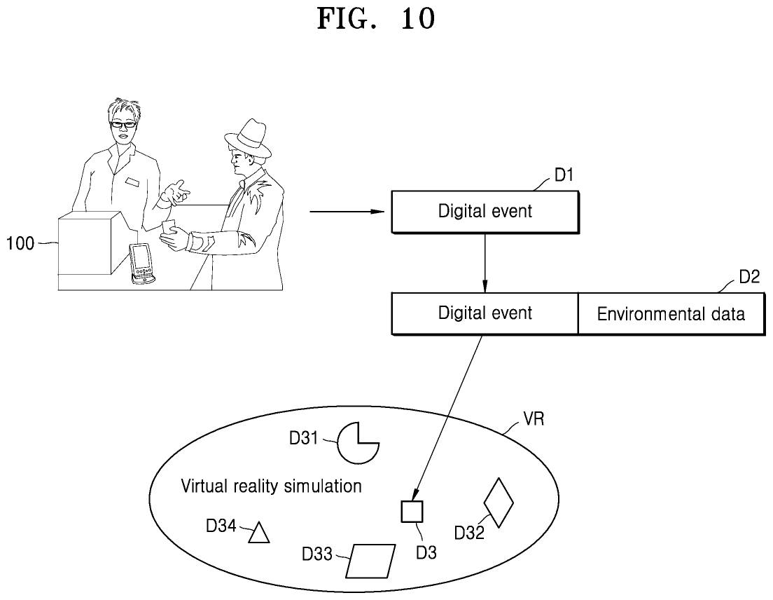

FIG. 10 is a diagram for explaining a process of generating data using a data processing system.

Referring to FIG. 10, when a card transaction is performed using the user terminal 100 installed in a shop, the financial company server 400 generates transaction data corresponding to the transaction. The financial company server 400 transmits the transaction data to the user terminal 100 of a user, i.e., the actor of the transaction.

The data processing server 300 may generate processed transaction data D3 from transaction data D1, using context data, which is collected from the user terminal 100 receiving the transaction data D1 or received from an external device. The data processing server 300 creates a virtual space VR and deploys the processed transaction data D3. At this time, the virtual space VR may be a location space, e.g., a map. In the location space, deployment information of the processed transaction data D3 may be determined based on location-related data, e.g., a transaction occurrence location, included in the processed transaction data D3.

The virtual space VR may be a time space such as a calendar or a time table. In the time space, deployment information of the processed transaction data D3 may be determined based on time-related data, e.g., a transaction occurrence time, included in the processed transaction data D3.

In one or more embodiments, in transaction amount space, deployment information of the processed transaction data D3 may be determined based on amount-related data, e.g., a total transaction amount or a unit price, included in the processed transaction data D3. The virtual space VR may be created in correspondence to complex information including a location and a time. In this case, deployment information of the processed transaction data D3 may be determined taking into account location-related data and time-related data.

The virtual space VR may be created by combining a transaction amount and an age group. Deployment information of the processed transaction data D3 may be determined taking into account transaction amount-related data and age group-related data. The processed transaction data D3 may be changed through clustering based on various criteria. Graphic data D31, D32, D33, and D34 having different shapes may be generated through grouping and deployed in the virtual space VR.

The devices described above may each be implemented as a hardware component, a software component, and/or a combination thereof. For example, the system and the components, which have been described in the embodiments, may be implemented using at least one general-use computer or special-purpose computer, like a processor, a controller, an arithmetic logic unit (ALU), a digital signal processor, a microcomputer, a field programmable gate array (FPGA), a programmable logic unit (PLU), a microprocessor, or any other device that can execute and respond an instruction. A processing device may run an OS and at least one software application executed on the OS. A processing device may access, store, handle, process, and generate data in response to the execution of software. To promote understanding, it has been described in some cases that a single processing device is used, but it will be understood by one of ordinary skill in the art that a processing device may include a plurality of processing elements and/or a multi-type processing element. For example, a processing device may include a plurality of processors or a single processor and a single controller. In addition, a different configuration like a parallel processor may be used.

Software may include a computer program, code, instructions, or a combination of at least one of them, and may configure a processing device to operate as desired or may independently or collectively instruct a processing device. Software and/or data may be permanently or temporarily embodied in a certain type of machine, a component, a physical device, virtual equipment, a computer storage medium or device, or a propagated signal wave such that a processing device analyzes the software and/or the data or is provided with an instruction or data. Software can also be distributed over network-coupled computer systems so that the software is stored and executed in a distributed manner. Software and data may be stored in at least one computer-readable recording medium.

The method according to embodiments can be embodied as program instructions executable using various computer devices and recorded on a computer-readable recording medium. The computer-readable recording medium may have recorded thereon a program instruction, a data file, a data structure, or a combination thereof. The program instruction recorded in the medium may be specially designed or configured for the embodiments or may be known to and used by those of skilled in computer software. Examples of the computer-readable recording medium include magnetic media (e.g., hard disks, floppy disks, and magnetic tapes), optical media (e.g., CD-ROMs and DVDs), magneto-optical media (e.g., floptical disks), and hardware devices (e.g., ROM, RAM, and flash memory) that are specially configured to store and execute program instructions. Examples of the program instructions include machine code created by a compiler and high-level language code that can be executed in a computer using an interpreter. The hardware devices may be configured to operate as at least one software module to perform operations of the embodiments and vice versa.

According to the embodiments, transaction-related big data using transaction information may be generated.

While embodiments have been described with reference to particular embodiments and drawings, various changes and modifications may be made in the above descriptions by those of ordinary skill in the art. For example, even when the techniques described above are performed in different order than described above, and/or the components such as systems, structure, devices, circuits, etc. described above are coupled to or combined with each other in different manners than described above or substituted or replaced with other components or equivalents, proper results may be obtained.

Therefore, other implements, other embodiments, and equivalents to the scope of the claims are included in the scope of the claims described below.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A method of processing data using transaction information, the method comprising:
a user terminal detecting context data related to transaction data through one of a sensor unit and a communication unit;
the user terminal generating transaction-context data regarding a transaction, taking into account the context data related to the transaction data;
the user terminal generating processed transaction data based on the transaction-context data; and
the user terminal outputting the processed transaction data through an output unit.

2. The method of claim 1, wherein
the outputting of the processed transaction data comprises:
rendering a virtual space taking into account a piece of attribution information selected from the context data and calculating deployment information of the transaction data to correspond to the piece of attribution information in the virtual space; and
deploying and displaying the processed transaction data in the virtual space based on the deployment information.

3. The method of claim 1, wherein
the generating of the transaction-context data comprises
generating the transaction-context data using the context data related to the transaction data, the transaction-context data including means information, occurrence period information, an amount, an occurrence location, an occurrence time, and an accumulated amount on a corresponding means with respect to the transaction.

4. The method of claim 1, wherein
the outputting of the processed transaction data comprises
outputting only part of the processed transaction data according to a user input.

5. The method of claim 1, wherein
the transaction-context data
is generated in correspondence to the transaction of a user in connection with context data received through an external server.

6. The method of claim 1, wherein
the transaction data
is generated when a user input matching a certain condition is received.

7. The method of claim 1, wherein
the context data
is detected in connection with a generation time of the transaction data when the transaction data is generated before the transaction data is received.

8. The method of claim 1, wherein
the context data
is generated in the user terminal near a generation time of the transaction data and
includes at least one selected from a photograph, a posting, and a memo, each being generated using an application installed in the user terminal.

9. A computer program stored in a computer-readable storage medium and, when executed using a computer, performing a method of processing data using transaction information, wherein the method comprises:
a user terminal detecting context data related to transaction data through one of a sensor unit and a communication unit;
the user terminal generating transaction-context data regarding a transaction, taking into account the context data related to the transaction data;
the user terminal generating processed transaction data based on the transaction-context data; and
the user terminal outputting the processed transaction data through an output unit.

10. The computer program of claim 9, wherein
the outputting of the processed transaction data comprises:
rendering a virtual space taking into account a piece of attribution information selected from the context data and calculating deployment information of the transaction data to correspond to the attribution information in the virtual space; and
deploying and displaying the processed transaction data in the virtual space based on the deployment information.

11. The computer program of claim 9, wherein
the generating of the transaction-context data comprises
generating the transaction-context data using the context data related to the transaction data, the transaction-context data including means information, occurrence period information, an amount, an occurrence location, an occurrence time, and an accumulated amount on a corresponding means with respect to the transaction.

12. The computer program of claim 9, wherein
the outputting of the processed transaction data comprises outputting only part of the processed transaction data according to a user input.

13. The computer program of claim 9, wherein
the transaction-context data
is generated in correspondence to the transaction of a user in connection with context data received through an external server.

14. The computer program of claim 9, wherein
the transaction data
is generated when a user input matching a certain condition is received.

15. The computer program of claim 9, wherein
the context data
is detected in connection with a generation time of the transaction data when the transaction data is generated before the transaction data is received.

16. The computer program of claim 9, wherein
the context data
is generated in the user terminal near a generation time of the transaction data and
includes at least one selected from a photograph, a posting, and a memo, each being generated using an application installed in the user terminal.
